(19) United States
(12) Patent Application Publication
(10) Pub. No.: US 2025/0306847 A1
(43) Pub. Date: Oct. 2, 2025

(54) AUDIO INTERCEPTION AND ROUTING IN AN AUDIO DEVICE

(71) Applicant: Logitech Europe S.A., Lausanne (CH)

(72) Inventors: Hashmat Afzali, Fremont, CA (US); John Dittlinger, Vancouver, WA (US); Edison David, San Jose, CA (US); Joe Lu, Santa Clara, CA (US)

(21) Appl. No.: 18/621,818

(22) Filed: Mar. 29, 2024

(51) Int. Cl. G06F 3/16; H04N 7/015; H04S 3/00

(52) U.S. Cl. CPC G06F 3/162; H04N 7/015; H04S 3/008; H04S 2400/01; H04S 2400/13

(57) ABSTRACT

Audio/video base stations may include a plurality of audio/video input ports. The base stations may include an audio/video output port. The base stations may include a communication interface that is coupleable with an audio transceiver. The base stations may include one or more processors. The base stations may include a memory device having instructions stored thereon that, when executed by the one or more processors, cause the audio/video base station to detect that the audio transceiver has been undocked from the audio/video base station. The instructions may further cause the base station to, in response to detecting that the audio transceiver has been undocked from the audio/video base station, automatically switching an audio output signal from the audio/video output port to the communication interface while continuing to transmit a video output signal to the audio/video output port.

### BACKGROUND OF THE INVENTION

As the popularity of online video gaming increases, so too does the popularity of chat sessions while playing the games. The chat sessions may be between players and/or may be established to enable a player to record commentary while playing a game for live or on-demand streaming sessions. Many players may utilize different audio and/or video hardware and/or services while playing and/or producing content, which may necessitate switching audio and/or video inputs across one or more audio and/or video output devices. Typically, this requires players to interact with a number of different pieces of hardware to switch between different input and output devices. Therefore, improvements in the ability to switch audio/video inputs are desired.

### BRIEF SUMMARY OF THE INVENTION

Audio/video base stations may include a plurality of audio/video input ports. The base stations may include an audio/video output port. The base stations may include a communication interface that is coupleable with an audio transceiver. The base stations may include one or more processors. The base stations may include a memory device having instructions stored thereon that, when executed by the one or more processors, cause the audio/video base station to detect that the audio transceiver has been undocked from the audio/video base station. The instructions may further cause the base station to, in response to detecting that the audio transceiver has been undocked from the audio/video base station, automatically switching an audio output signal from the audio/video output port to the communication interface while continuing to transmit a video output signal to the audio/video output port.

In some embodiments, the base stations may include a plurality of audio transmission ports. Each of the plurality of audio transmission ports may be associated with a respective one of the plurality of audio/video input ports. The instructions may further cause the audio/video base station to terminate a first audio channel between the audio/video output port and a respective audio transmission port associated with an active one of the plurality of audio/video input ports. The instructions may further cause the audio/video base station to establish a second audio channel between the communication interface and the respective audio transmission port associated with the active one of the plurality of audio/video input ports. The instructions may further cause the audio/video base station to receive an input from the audio transceiver to switch to a different one of the plurality of audio/video input ports. The instructions may further cause the audio/video base station to, in response to receiving the input, automatically: terminate the second audio channel and establish a third audio channel between the communication interface and the respective audio transmission port associated with the different one of the plurality of audio/video input ports. At least some of the plurality of audio transmission ports may include descriptors associated with a specific audio/video input device. The instructions may further cause the audio/video base station to receive an input from the audio transceiver to switch to a different one of the plurality of audio/video input ports. The instructions may further cause the audio/video base station to, in response to receiving the input, automatically: halt transmission of the video output signal to the audio/video output port, halt transmission of the audio output signal, transmit a new audio output signal associated with the different one of the plurality of audio/video input ports to the communication interface, and transmit a new video signal associated with the different one of the plurality of audio/video input ports to the audio/video output port.

The base stations may include a plurality of visible indicators. Each of the plurality of visible indicators may be associated with a respective one of the plurality of audio/video input ports. The instructions may further cause the audio/video base station to activate a respective one of the visible indicators associated with a selected one of the plurality of audio/video input ports that is associated with the video output signal that is being transmitted to the audio/video output port. The instructions may further cause the audio/video base station to receive an input from the audio transceiver to switch to a different one of the plurality of audio/video input ports. The instructions may further cause the audio/video base station to deactivate the respective one of the visible indicators associated with the selected one of the plurality of audio/video input ports. The instructions may further cause the audio/video base station to activate a respective one of the visible indicators associated with the different one of the plurality of audio/video input ports. The instructions may further cause the audio/video base station to after a predefined time delay has elapsed: halt transmission of the video output signal to the audio/video output port, halt transmission of the audio output signal, transmit a new audio output signal associated with the different one of the plurality of audio/video input ports to the communication interface, and transmit a new video signal associated with the different one of the plurality of audio/video input ports to the audio/video output port.

Some embodiments of the present technology may encompass methods of switching audio channels of a base station. The methods may include detecting, by a base station, that an audio transceiver has been undocked from the base station. The methods may include in response to detecting that the audio transceiver has been undocked from the base station, automatically: halting transmission, by the base station, of a first audio signal associated with a first input device to a first selected output device and transmitting, by the base station, the first audio signal to the audio transceiver while continuing to transmit a first video signal associated with the first input device to the first selected output device. The methods may include receiving, by the base station, an input from the audio transceiver to switch to a second input device. The methods may include in response to receiving the input, automatically: halting transmission, by the base station, of the first video signal to the first selected output device, halting transmission, by the base station, of the first audio signal to the audio transceiver, transmitting, by the base station, a second audio signal associated with the second input device to the audio transceiver, and transmitting, by the base station, a second video signal associated with the second input device to a second selected output device.

In some embodiments, the methods may include establishing, by the base station an audio channel between the audio transceiver and an audio transmission port of the base station that is associated with the second input device. The methods may include receiving, by the base station, a mixing command associated with a volume level of one or both of the second audio signal and the audio channel. The methods may include adjusting, by the base station, a volume of the one or both of the second audio signal and the audio channel in response to receiving the mixing command. The mixing command may include an input received from the audio transceiver. The mixing command may include an input received from audio mixing software executed on an external device that is communicatively coupled with the base station. Adjusting the volume of the one or both of the second audio signal and the audio channel may include raising the volume of one of the second audio signal and the audio channel and lowering the volume of the other of the second audio signal and the audio channel without adjusting a master volume of the audio transceiver. The methods may include detecting, by the base station, that the audio transceiver has been docked with the base station. The methods may include, in response to detecting that the audio transceiver has been docked with the base station, automatically: halting transmission, by the base station, of the second audio signal associated with the second input device to the audio transceiver and transmitting, by the base station, a third audio signal associated with the second input device to the second selected output device while continuing to transmit the second video signal to the second selected output device. The first output device and the second output device may be the same device.

Some embodiments of the present invention may encompass audio/video systems. The systems may include an audio transceiver. The audio transceiver may include input select interface. The audio transceiver may include a volume mixing interface. The systems may include a base station. The base station may include a plurality of audio/video input ports. The base station may include an audio/video output port. The base station may include a communication interface that is coupled with the audio transceiver. The base station may include one or more processors. The base station may include a memory device having instructions stored thereon that, when executed by the one or more processors, cause the base station to detect that the audio transceiver has been undocked from the base station. The instructions may further cause the base station to, in response to detecting that the audio transceiver has been undocked from the base station, automatically switching an audio signal from the audio/video output port to the communication interface while continuing to transmit a video signal to the audio/video output port.

In some embodiments, the instructions may further cause the base station to receive an input from the input select interface to switch to a different one of the plurality of audio/video input ports. The instructions may further cause the base station to, in response to receiving the input, automatically: halt transmission of the video output signal to the audio/video output port;

halt transmission of the audio output signal, transmit a new audio output signal associated with the different one of the plurality of audio/video input ports to the communication interface, and transmit a new video signal associated with the different one of the plurality of audio/video input ports to the audio/video output port. Detecting that the audio transceiver has been undocked from the base station may include the base station detecting that an electrical connector of the audio transceiver has been disengaged from an electrical connector of the base station. The communication interface may include a radio connection established between the audio transceiver and the base station. The base station may include a Bluetooth antenna. The audio transceiver may include one or more controls for the Bluetooth antenna. The instructions may cause the base station to receive an audio transmission from a connected device via the Bluetooth antenna. The instructions may cause the base station to transmit the audio transmission to the audio transceiver over the communication interface. The audio transceiver may include a headset.

### BRIEF DESCRIPTION OF THE DRAWINGS

A further understanding of the nature and advantages of the disclosed technology may be realized by reference to the remaining portions of the specification and the drawings.

FIG. 1 illustrates a schematic view of an audio system in accordance with embodiments of the present invention.

FIGS. 2A-2G illustrate operations of an audio system with a number of connected input and output devices in accordance with embodiments of the present invention.

FIG. 3 illustrates operations of a method of operating a base station in accordance with embodiments of the present invention.

FIG. 4 is a block diagram of a computer system in accordance with embodiments of the present invention.

Several of the figures are included as schematics. It is to be understood that the figures are for illustrative purposes and are not to be considered of scale unless specifically stated to be of scale. Additionally, as schematics, the figures are provided to aid comprehension and may not include all aspects or information compared to realistic representations and may include exaggerated material for illustrative purposes.

### DETAILED DESCRIPTION OF THE INVENTION

The subject matter of embodiments of the present invention is described here with specificity to meet statutory requirements, but this description is not necessarily intended to limit the scope of the claims. The claimed subject matter may be embodied in other ways, may include different elements or steps, and may be used in conjunction with other existing or future technologies. This description should not be interpreted as implying any particular order or arrangement among or between various steps or elements except when the order of individual steps or arrangement of elements is explicitly described.

Embodiments of the present technology encompass audio/video systems and methods of operating audio/video systems that may enable a user to switch audio and/or video input and/or output devices using controls on an audio transceiver, such as a gaming headset. The audio systems may include a base station that may serve as a hub that connects the audio transceiver to one or more audio and/or video input devices and one or more audio and/or video output devices. By having a sophisticated base station that handles all audio and video switching, audio mixing, and volume adjustments, it may be possible to design a simpler audio transceiver, as the audio transceiver may only need one or more interfaces that enable a user to remotely control features of the base station. Embodiments of audio systems in accordance with the present invention may enable a user to switch audio/video inputs and outputs and/or control audio levels using only the audio transceiver, without the need to otherwise interact with the base station and/or connected input/output devices.

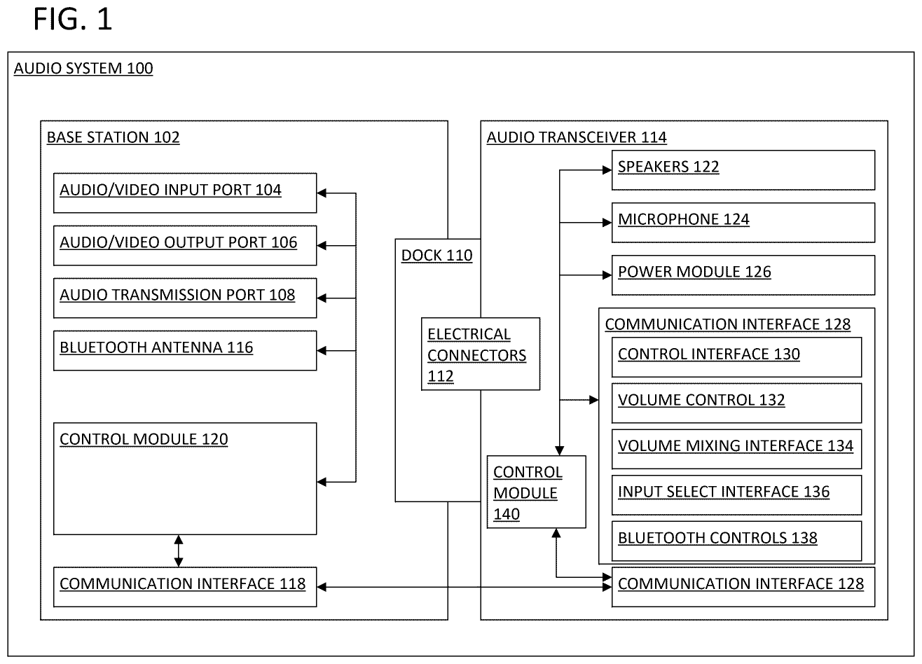

Turning now to FIG. 1, a system diagram of one embodiment of an audio system 100 is illustrated. The audio system 100 may include a base station 102 that may be configured to interface with a number of different audio and/or video input and/or output devices. For example, the base station 102 may include a plurality of audio/video input ports 104. Each audio/video input port 104 may be coupled with a respective input device via one or more cables. The input devices may be, for example, video game consoles, personal computers, tablet computers, mobile phones, video streaming devices, video player devices (e.g., DVD players, Blu-ray players, etc.), and/or other audio/video input devices. Each input device may be coupled with a respective one of the audio/video input ports 104. For example, the audio/video input ports 104 may enable the audio/video input devices to transmit audio and video signals to the base station 102 for output on one or more audio and/or video output devices. For example, where the audio/video input devices are gaming consoles, the audio and video signals may include the sounds and visuals of video game software being executed on the audio/video input devices. Where the audio/video input devices are video streaming devices and/or video player devices, the audio and video signals may include the sounds and visuals of digital media, such as music, television shows, movies, and the like. Other types of video and audio may be transmitted from the audio/video input devices in various embodiments.

Each audio/video input port 104 may include a high-definition multimedia interface (HDMI) port, a universal serial bus (USB) port (e.g., USB 3.0, etc.), an analog port, a Lightning connector, and/or other connector interface that supports transmission of audio and video signals. In some embodiments, each audio/video input port 104 may have a same form, while in other embodiments one or more of the audio/video input ports 104 have different forms. For example, the base station 102 may include two audio/video input ports 104 that take the form of HDMI ports. As just one example, each of the HDMI ports may be designed to interface with a given gaming console (or other input device), although other configurations are possible. The base station 102 may include any number of audio/video input ports 104. For example, the base station 102 may include two or more audio/video input ports, three or more audio/video input ports, four or more audio/video input ports, five or more audio/video input ports, or more. While referred to as an input port, it will be appreciated that the audio/video input ports 104 may support bi-directional transmission of signals in various embodiments.

The base station 102 may include one or more audio/video output ports 106 that may be coupled with a respective audio/video output device via one or more cables. The output devices may be, for example, televisions, monitors, tablet computers, and/or other audio/video output devices. Each output device may be coupled with one of the audio/video input ports 106. For example, the audio/video output ports 104 may enable the base station 102 to transmit audio and/or video signals from the input devices coupled with the audio/video input ports 104 to the output device connected to the audio/video output port 106. Each audio/video output port 106 may include an HDMI port, a USB port, an analog port, a Lightning connector, and/or other connector interface that supports transmission of audio and video signals. In some embodiments, each audio/video output port 106 may have a same form, while in other embodiments one or more of the audio/video output ports 106 have different forms. For example, the base station 102 may include a single audio/video input port 106 that take the form of an HDMI port that enables a television or other monitor to be connected to the base station 102, although other configurations are possible. The base station 102 may include any number of audio/video output ports 106. For example, the base station 102 may include one or more audio/video output ports, two or more audio/video output ports, three or more audio/video output ports, four or more audio/video output ports, five or more audio/video output ports, or more. While referred to as an output port, it will be appreciated that the audio/video output ports 106 may support bi-directional transmission of signals in various embodiments.

The base station 102 may include a plurality of audio transmission ports 108. The audio transmission ports 108 may be coupled with a given audio/video input device and/or output device and may enable a second set of audio channels to be established simultaneously between the base station 102 and one or more input/output devices. For example, a first audio channel may be established between an input device, the base station 102, and an output device via one of the audio/video input ports 104 and one of the audio/video output ports 106, while a second audio channel may be established between the input device, the base station 102, and the output device via one of the audio transmission ports 108 and a connected audio transceiver (as will be discussed in greater detail below). For example, the first audio channel may be used to play audio from the video game or other software being executed on a gaming console (or other device), while the second channel may facilitate chat audio, such as player commentary or discourse with other players of an online multiplayer game. In some embodiments, each of the audio transmission ports 108 may be associated with a specific audio/video input port 104. For example, each audio/video input port 104 may include a dedicated audio transmission port 108 to facilitate chat functionality while using an input device connected to a respective audio/video input port 104. This may be particularly useful in certain embodiments (such as those in which the audio transmission ports 108 include USB ports), as the port descriptors may vary for different input devices such that there may be cross-compatibility issues if one or more of the audio/video input ports 104 do not have a dedicated audio transmission port 108 and/or if an incompatible input device is interfaced with a given audio transmission port 108. In such embodiments, some or all of the audio transmission ports 108 may have port descriptors that are tied to specific brands, models, and/or types of input devices. In such embodiments, the base station 102 may include labels, instructions, and/or other identifiers that help guide a user on what type(s) of device may be interfaced with a given audio transmission port 108 and/or associated audio/video input port 104.

Each audio transmission port 108 may include a USB port (e.g., USB 3.0, etc.), Lightning connector, a Sony/Philips Digital Interface (S/PIDF) port, an optical audio port, a Bluetooth connection, a network audio over Wi-Fi or Ethernet connection, and/or other connector interface that supports bi-directional transmission of audio signals. In some embodiments, each audio transmission port 108 may have a same form, while in other embodiments one or more of the audio transmission ports 108 have different forms. For example, as illustrated, the base station 102 includes three audio transmission ports 108 that each take the form of USB ports. The base station 102 may include any number of audio transmission ports 108. For example, the base station 102 may include one or more audio transmission ports, two or more audio transmission ports, three or more audio transmission ports, four or more audio transmission ports, five or more audio transmission ports, or more. In some embodiments, a number of the audio transmission ports 108 may match a number of audio/video input ports 104 such that each audio-video input port 104 may have a dedicated audio transmission port 108 to facilitate simultaneous transmission of audio signals for game and chat functions. In other embodiments, a number of the audio transmission ports 108 may be different than a number of audio/video input ports 104. For example, the base station 102 may include one more audio transmission port 108 (three) than audio/video input ports 104 (two). This enables each audio-video input port 104 to have a dedicated audio transmission port 108 while also providing an additional audio transmission port 108 to facilitate chat functionality with an input/output device. For example, the additional audio transmission port 108 may be used to connect the base station 102 with a personal computer or other device that has one or more dedicated or attached display monitors. Such external devices may be directly connected and/or integrated with video display monitors and may not require the base station 102 to handle any video signals. Therefore, when coupled with such an external device, the base station 102 may receive game and/or chat audio from the external device and transmit the audio to the audio transceiver 114.

The base station 102 may include a dock 110 that may be used to receive and/or charge an audio transceiver 114 that is communicatively coupled with the base station 102. For example, the dock 110 may include a cradle and/or other structure that may securely receive and retain the audio transceiver 114 atop a portion of the base station 102 (or associated stand of the base station 102). The dock 110 may include one or more electrical connectors 112 that may be exposed and may be designed to interface with corresponding connectors of the audio transceiver 114 when the audio transceiver 114 is engaged with the dock 110. The electrical connectors 112 may include one or more pins or other connectors that may transmit power (e.g., for charging the audio transceiver 114) and/or data (e.g., firmware updates), may be used to detect when the audio transceiver 114 is engaged with the dock 110 (e.g., is docked or undocked), and/or for any other purpose. For example, to determine whether the audio transceiver 114 is docked or undocked, the base station 102 (such as via one or more processors of the base station 102) may involve detecting whether an electrical connector of the audio transceiver 114 has been disengaged from a respective electrical connector 112 of the base station 102. If the electrical connector of the audio transceiver 114 has been disengaged from a respective electrical connector 112 of the base station 102, the base station 102 may determine that the audio transceiver 114 is undocked from the base station 102. If the electrical connector of the audio transceiver 114 is detected as being engaged with the respective electrical connector 112 of the base station 102, the base station 102 may determine that the audio transceiver 114 is docked with the base station 102.

When the audio transceiver 114 is docked, the base station 102 may function as a pass-through device that enables audio and/or video signals to be transmitted from one or more input devices to one or more output devices. When the audio transceiver 114 is undocked, the base station 102 may automatically reroute audio signals from one or more input devices to the audio transceiver 114. Docking and undocking the audio transceiver 114 may automatically cause the base station 102 to switch modes of operation to properly route the audio signals to the output device or audio transceiver 114.

In some embodiments, the base station 102 may include a Bluetooth (or other wireless communication protocol) antenna 116 that may be used to transmit audio between the base station 102 and a device that is connected to the base station 102 via the Bluetooth antenna 116. For example, a user may connect a mobile phone, tablet computer, and/or other computing device to the base station 102 via the Bluetooth antenna 116, which may enable audio (such as telephone conversations, music, audio from videos, etc.) to be transmitted from the connected device to the base station 102 for subsequent transmission to the audio transceiver 114.

The base station 102 may also include a communication interface 118 that may be used to transmit audio signals between the base station 102 and the audio transceiver 114. For example, when the audio transceiver 114 is undocked from the base station 102, the communication interface 118 may be activated such that audio from the input device and/or Bluetooth antenna 116 is transmitted to the audio transceiver using the communication interface 118. If multiple audio channels are established (e.g., game audio and chat audio), both channels of the audio may be transmitted to the audio transceiver 114 via the communication interface 118. The communication interface 118 may include a wired connection (which may transmit audio and/or power the audio transceiver 114) and/or a wireless connection. For example, the communication interface 118 may include an antenna that may be used to establish a radio connection between the audio transceiver 114 and the base station 102. The radio connection may be selected to operate at a frequency that is different than common wireless (e.g., Wi-Fi, Bluetooth, etc.) frequencies, cellular frequencies, device controller frequencies, and/or other device frequencies to help reduce the amount of interference on the radio connection.

The base station 102 may include one or more visible indicators 150 that may each be associated with one of the audio/video input ports 104 and/or one of the audio transmission ports 108. For example, each visible indicator 150 may include a light, display, and/or other element that may be activated. In a particular embodiment, each visible indicator 150 may be or include a light emitting diode (LED) that may be activated (e.g., illuminated) when the associated audio/video input port 104 is active for transmission of audio and/or video signals between the base station 102 and a connected input device. When an audio/video input port 104 is not active (e.g., a different audio/video input port 104 and/or audio transmission port 108 is active), the visible indicator 150 associated with the inactive audio/video input port 104 may be deactivated. This may enable the visible indicators 150 to serve as indications as to which input device is currently active for transmission of audio and/or video signals to the base station 102.

The base station 102 may include a control module 120 that may include one or more processors and/or memory devices. The memory devices may include instructions stored thereon that, when executed by the one or more processors, may cause the base station 102 to perform the various functions of the base station 102 as will be discussed in greater detail below. The control module 120 may be electrically coupled with the audio/video input ports 104, audio/video output ports 106, audio transmission ports 108, electrical connectors 112, Bluetooth antenna 116, communication interface 118, etc. to control the functionality of the connected base station components.

The audio transceiver 114 may be any device that may send and receive audio signals. For example, the audio transceiver may be a headset that includes at least one speaker and/or one microphone. In a particular embodiment, the audio transceiver 114 may be a gaming headset that is usable to play audio (possibly including gaming audio) from an input device, as well as play and receive chat audio. For example, the audio transceiver 114 may include one or more speakers 122, which may be positioned in and/or on earpieces of a headset structure. The speakers 122 may emit audio associated with game, chat, telephone, music, and/or other inputs. The audio transceiver 114 may include one or more microphones 124, which may be coupled with the headset structure. The microphones 124 may receive audio, such as player chat comments, voice commands, and/or other sound inputs that may be transmitted back to the base station 102 for subsequent transmission to an activated input device (e.g., via one of the audio/video input ports 104) and/or other connected device. For example, chat audio may be relayed to the input device (e.g., via the audio transmission port 108) for subsequent transmission/playback as part of in-game audio and/or may be relayed to a streaming/recording device for producing online media content, such as for social media platforms (e.g., Twitch, YouTube, Steam, Discord, etc.).

The audio transceiver 114 may include a power module 126. The power module 126 may store and or otherwise provide power to the audio transceiver 114. For example, in embodiments in which the communication interface 118 includes a wired connection, the power module 126 may receive power from the base station 102 via the communication interface 118. In other embodiments, the power module 126 may include one or more batteries that may be used to power the audio transceiver 114. The batteries may be charged using a power cable and/or by docking the audio transceiver 114 with the base station 102, which may then transmit power to the power module 126 via one or more of the electrical connectors 112. In some embodiments, the audio transceiver 114 and the base station 102 may be an integrated assembly (e.g., specifically designed to work together), while in other embodiments, the base station 102 may be compatible with a number of different brands, models, and/or types of audio transceivers 114.

The audio transceiver 114 may include a communication interface 128 that facilitates communication between the base station 102 and the audio transceiver 114. The communication interface 128 may operate using a same communication protocol as the communication interface 118 of the base station 102. For example, the communication interface 128 may include a wired and/or wireless connection. In a particular embodiment, the communication interface 128 may include at least one antenna that facilitates establishment of the radio connection between the base station 102 and the audio transceiver 114 using a predefined transmission frequency. The interaction between the communication interfaces 118, 128 of the base station 102 and the audio transceiver 114 may facilitate all communications (e.g., audio signals, control signals, etc.) between the base station 102 and the audio transceiver 114 when the audio transceiver 114 is undocked from the base station 102. For example, audio from a selected input device (e.g., game volume, music, television, other video volume, etc.) connected with an audio/video input port 104, telephone audio from a Bluetooth device connected to the base station 102 via the Bluetooth antenna 116, and/or chat audio via an audio transmission port 104 may be transmitted to the audio transceiver 114 via the communication interfaces 118, 128, while chat audio received at the microphone 124 of the audio transceiver 114 may be transmitted to the base station 102 via the communication interfaces 118, 128. Similarly, control inputs from the audio transceiver 114 (e.g., Bluetooth controls, audio/video input device switching, volume/audio mixing controls, and/or other control inputs) may be transmitted to the base station 102 via the communication interfaces 118, 128. In some embodiments, the communications interfaces 118, 128 may include one or more audio channels that handle the transmission of audio signals and one or more data channels that handle the transmission of control signals and/or other data between the audio transceiver 114 and the base station 102.

The audio transceiver 114 may include a control interface 130 that may enable the user to control one or more functions of the base station 102 and/or audio transceiver 114. For example, the control interface 130 may include a volume control 132 that controls the master volume of audio emitted by the speakers 122 of the audio transceiver 114. The volume control 132 may include a volume wheel, one or more volume buttons, and/or other input mechanisms that enable a user to increase, decrease, and/or mute the master volume. In some embodiments, inputs from the volume control 132 may be processed by the audio transceiver 114 (such as using a control module 140), which may then make any adjustments to the master volume. In other embodiments, the inputs from the volume control 132 may be transmitted to the base station 102 via the communication interface 128. The base station 102 may then make a corresponding adjustment to the master volume of one or more audio signals (e.g., game audio and/or chat audio) that are transmitted to the audio transceiver 114 via the communication interface 118.

The control interface 130 may include a volume mixing interface 134. The volume mixing interface 134 may enable the user to control the mixing (e.g., relative volume) of one or more sources of audio. For example, when a user is playing a game and chatting with other players, the speakers 122 of the audio transceiver 114 may emit sound from a game audio channel and a chat audio channel. The volume mixing interface 134 may include one or more buttons or other control mechanisms that may be used to adjust a volume of the game channel relative to the chat channel. In some embodiments, adjustments made by the volume mixing interface 134 do not impact the master volume of the sound emitted by the speakers 122. For example, adjusting the mixing of the game channel and the chat channel may include raising the volume of the game signal and/or lowering a volume of the chat audio channel (or vice versa) without adjusting a master volume of the audio transceiver 114. For example, the game channel and chat channel may have default mixing of a 50:50 ratio in which both channels are at a same relative volume. A user may want to hear the chat more loudly without adjusting the master volume of the audio transceiver 114. The user may interact with the volume mixing interface 134 to increase the relative volume of the chat channel and/or lower the relative volume of the game channel such that the chat channel is louder than the game channel (e.g., a chat/game ratio of 60:40, 70:30, 80:20, 90:10, etc.). The volume mixing interface 134 may also enable one or both of the audio channels to be muted. In some embodiments, the inputs from the volume mixing interface 134 may be transmitted to the base station 102 via the communication interface 128. For example, a first button may change the ratio of game:chat audio to raise the relative volume level of the game audio while a second button may change the ratio of game:chat audio to raise the relative volume level of the chat audio. The base station 102 may then make a corresponding adjustment to the relative volumes of the different audio channels (e.g., game audio and/or chat audio) that are transmitted to the audio transceiver 114 via the communication interface 118.

The audio transceiver 114 may include an input select interface 136 that enables a user to change a selection of input devices. For example, a user may interact with one or more buttons and/or other inputs of the input select interface 136 to switch which input device is able to actively transmit audio and/or video signals to and from the base station 102. For example, the user may press a button of the input select interface 136 to cycle through the connected input devices, with each button press causing the base station 102 to change which input device (e.g., device coupled with an audio/video input port 104 and/or audio transmission port 108) is active. In some embodiments, a single button may be provided that enables the user to cycle through the connected input devices incrementally, with each press of the button sending a signal to the base station 102 (e.g., via the communication interface 128) that causes the base station 102 to increment the selection of input devices by one input device.

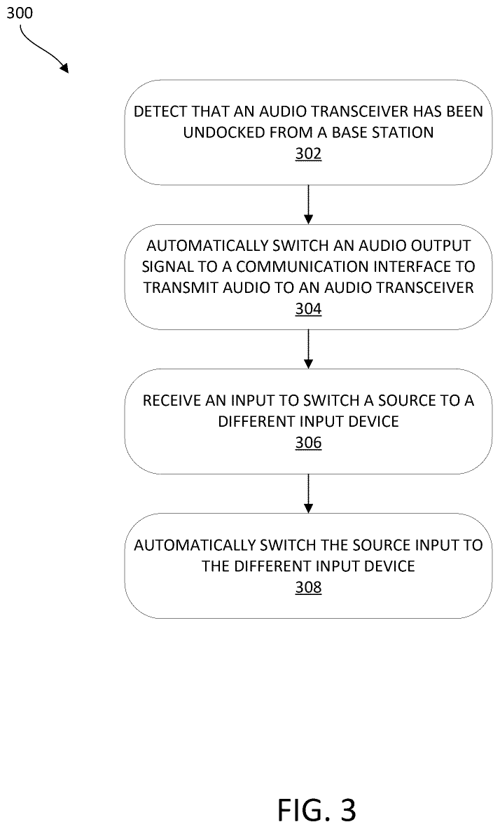

In some embodiments, switching the input device may involve the base station 102 halting transmission of a video signal from a first audio/video output port to an output device. The base station 102 may also halt transmission of a first audio signal to the audio transceiver 114. The base station 102 may transmit a second audio signal (e.g., a game audio signal) associated with a second input device to the audio transceiver 114, such as via the communication interface 118 of the base station 102. The base station 102 may transmit a second video signal associated with the second input device to the output device (or another output device). Additional details associated with the switching operations are described in relation to FIG. 3.

The audio transceiver 114 may include one or more Bluetooth controls 138 that are usable to control functionality of the Bluetooth antenna 116 of the base station 102. For example, the Bluetooth controls 138 may include one or more buttons, touchscreens, and/or other inputs that are coupled with a housing of the headset or other audio transceiver 114. The Bluetooth controls 138 may be used to turn on the Bluetooth antenna 116, turn off the Bluetooth antenna 116, pair an external device with the Bluetooth antenna 116, control audio playback functions associated with the Bluetooth antenna 116 (e.g., play/pause the audio, skip an audio track, cycle to a previous audio track, etc.) answer and/or hangup a call to the external device, and/or other function. Inputs to the Bluetooth controls 138 may cause signals to be transmitted to the base station 102 via the communication interface 128. The base station 102 may then perform a function associated with the signal from the input (e.g., turn the Bluetooth antenna 116 on/off, go into Bluetooth pairing mode, play/pause the audio, skip an audio track, cycle to a previous audio track, pickup/hangup a phone call, etc.). In some embodiments, volume control inputs for the Bluetooth antenna 116 may be included on the audio transceiver 114 (e.g., as part of the volume control 132 and/or volume mixing interface 134), while in other embodiments, the volume of Bluetooth audio may be adjusted using the external Bluetooth device that is providing the audio. In such embodiments, the Bluetooth volume may be adjusted without impacting the volume of other audio signals. In some embodiments, Bluetooth audio may be mixed with the game audio, chat audio, and/or other audio signal using the volume mixing interface 134.

In some embodiments, when the audio transceiver 114 is docked with the base station 102, the base station 102 may automatically disconnect the Bluetooth antenna 116 from the paired external device. When the audio transceiver 114 is undocked from the base station 102, the base station 102 may transmit audio between the audio transceiver 114 and the paired external device. In some embodiments, the Bluetooth audio may be unaffected by the base station 102 switching input devices for the game audio, chat audio, and/or other audio.

The audio transceiver 114 may include a controller 140 that may include one or more processors and/or memory devices. The memory devices may include instructions stored thereon that, when executed by the one or more processors, may cause the audio transceiver 114 to perform the various functions of the audio transceiver 114, such as sending signals associated with inputs from the control interface 130, volume control 132, volume mixing interface 134, input select interface 136, Bluetooth controls 138, etc. to the base station 102 over the communication interface 128. The control module 140 may be electrically coupled with speakers 122, microphone 124, power module 126, communication interface 128, control interface 130, volume control 132, volume mixing interface 134, input select interface 136, Bluetooth controls 138, etc. to control the functionality of the connected audio transceiver components.

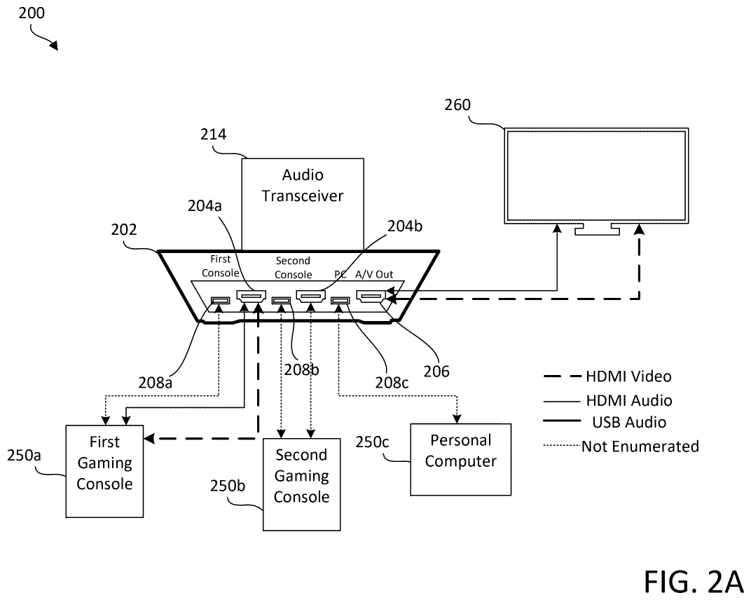

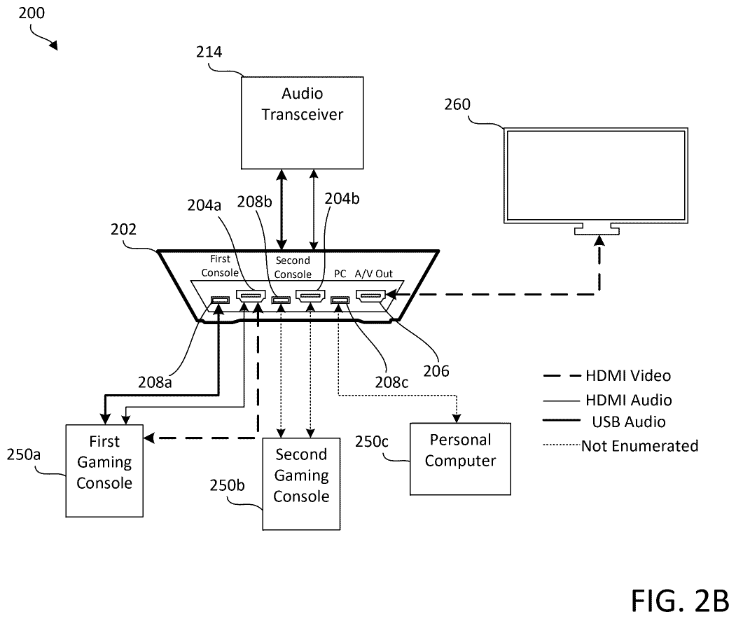

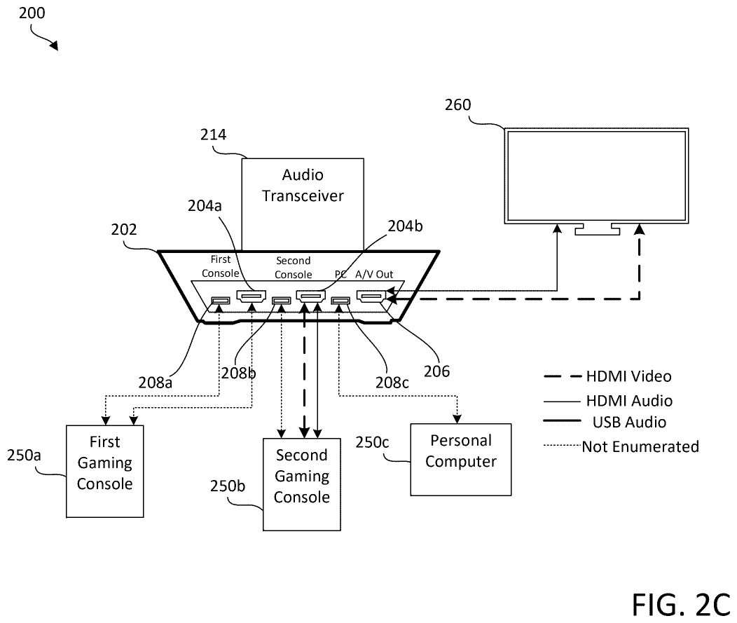

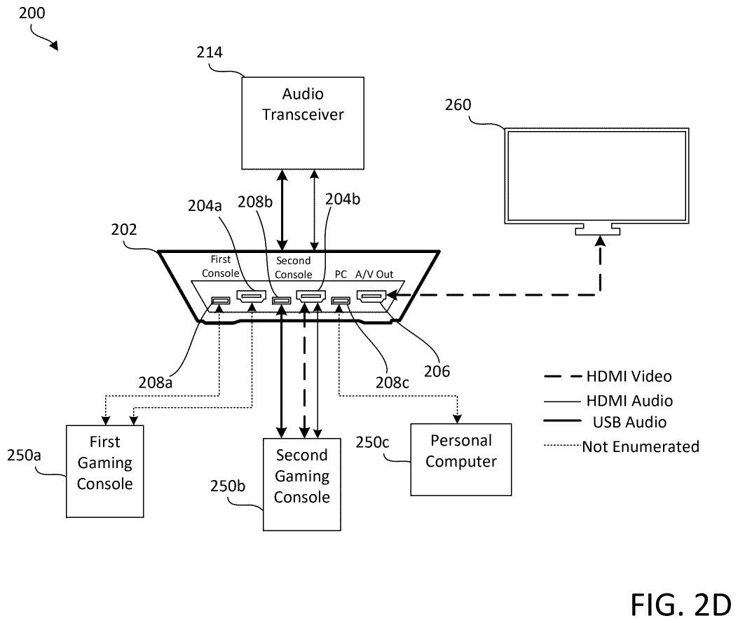

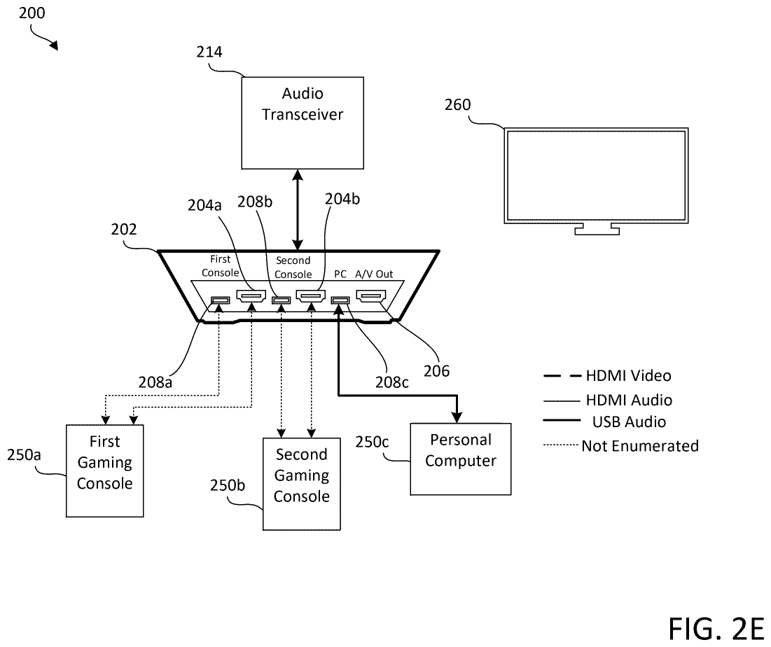

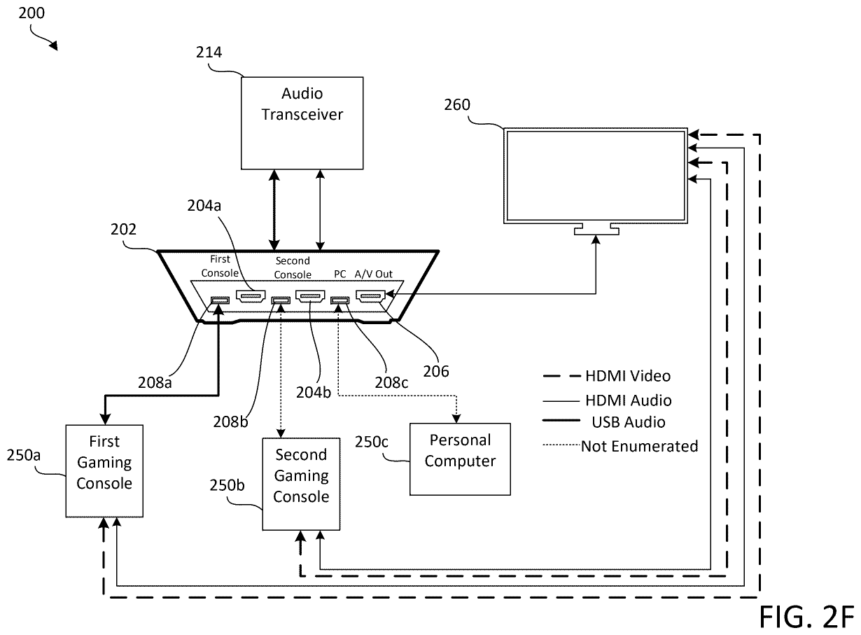

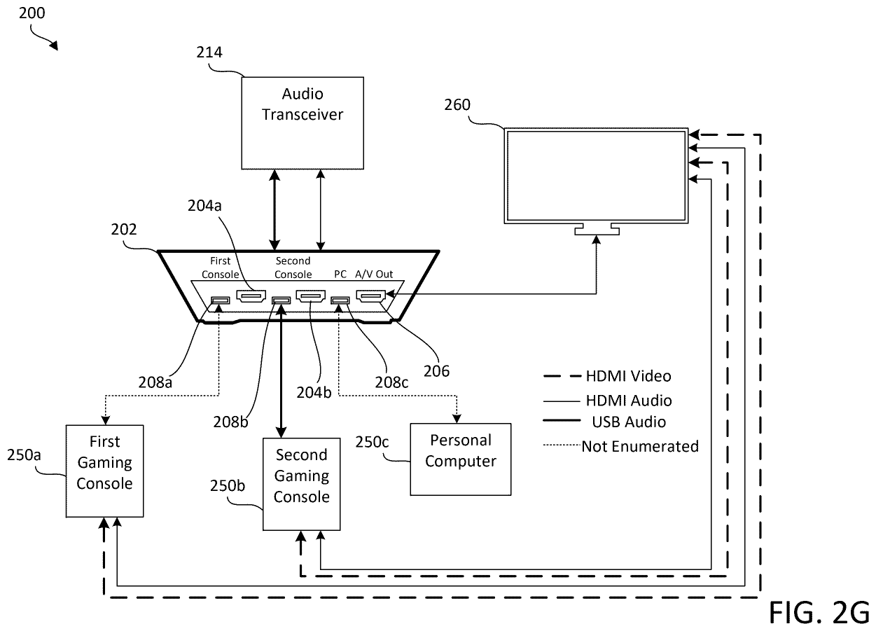

FIGS. 2A-2G illustrate operations of an audio system 200 interfaced with various input devices 250 and output devices 260. Audio system 200 may be similar to audio system 100 and may include any of the features described in relation to audio system 100. For example, the audio system 200 may include a base station 202 (which may be similar to base station 102) and an audio transceiver 214 (which may be similar to audio transceiver 114). As illustrated, the audio transceiver 214 is a gaming headset that is dockable with the base station 202, although the audio transceiver 214 may take other forms in various embodiments. As illustrated, the base station 202 includes two audio/video input ports 204 (which may be similar to audio/video input ports 104) that are each connected to a different input device 250. As illustrated, each audio/video input port 204 is an HDMI port, however, one or more of the audio/video input ports 204 may take other forms in various embodiments. As illustrated, a first audio/video input port 204a is connected with a first gaming console 250a and a second audio/video input port 204b is connected to a second gaming console 250b. In some embodiments, the audio/video input ports 204 may be specifically labeled and/or designed for use with a specific brand, model, and/or type of input device 250. It will be appreciated that one or more of the audio/video input ports 204 may be coupled with another type of input device in various embodiments. Additionally, in some embodiments, one or more of the audio/video input ports 204 may not be connected to any input device 250.

The base station 202 may include one or more audio/video output ports 206 (which may be similar to audio/video output ports 106) that may each be coupled with a respective audio/video output device 260 via one or more cables. As illustrated, the base station 202 includes a single audio/video output port 206 that is coupled with the audio/video output device 260, which takes the form of a television or other monitor in the illustrated embodiment. As illustrated, each audio/video output port 206 is an HDMI port, however, one or more of the audio/video output ports 206 may take other forms in various embodiments.

The base station 202 may include a plurality of audio transmission ports 208 (which may be similar to audio transmission ports 108) that are each connected to a different input device 250. As illustrated, each audio transmission port 208 is a USB port, however, one or more of the audio/video input ports 204 may take other forms in various embodiments. As illustrated, a first audio transmission port 208a is connected with the first gaming console 250a and a second audio transmission port 208b is connected to the second gaming console 250b. In the illustrated embodiment, the base station 202 includes a third audio transmission port 208c that is connected to a personal computer 250c. The personal computer 250c may include and/or be coupled directly with one or more dedicated monitors (e.g., different than output device 260) and therefore may not require the base station 202 to relay video signals, thus eliminating the need for a corresponding audio/video input port 204. In some embodiments, the audio transmission ports 208 may be specifically labeled and/or designed for use with a specific brand, model, and/or type of input device 250. Additionally, in some embodiments, one or more of the audio transmission ports 208 may not be connected to any input device 250. In some embodiments, some or all of the audio transmission ports 208 may have port descriptors that are tied to specific brands, models, and/or types of input devices 250. In such embodiments, the base station 202 may include labels, instructions, and/or other identifiers that help guide a user on what type(s) of device may be interfaced with a given audio transmission port 208 and/or associated audio/video input port 204.

FIG. 2A illustrates the audio system 200 with the audio transceiver 214 being docked with the base station 202 and with the first audio/video input port 204a in an active state. In this configuration, the gaming console 250a is able to transmit audio and video signals to the output device 260 via the base station 202. For example, audio/video signals from the gaming console 250a may be transmitted to the base station 202 via a cable that is connected with the first audio/video input port 204a. The base station 202 may transmit the audio/video signals from the gaming console 250a to the output device 260 via a cable that is connected to the audio/video output port 206. The audio transmission ports 208 and audio/video input port 204b are inactive, and no signals are transmitted via these ports.

FIG. 2B illustrates the audio system 200 with the audio transceiver 214 being undocked from the base station 202 and with the first audio/video input port 204a in an active state. Upon detecting that the audio transceiver 214 is undocked, the base station 202 may route audio from the gaming console 250a to the audio transceiver 214, rather than the output device 260. For example, in this configuration, the gaming console 250a is able to transmit audio and video signals to the output device 260 via the base station 202. For example, audio/video signals from the gaming console 250a may be transmitted to the base station 202 via a cable that is connected with the first audio/video input port 204a. The base station 202 may transmit the video signals from the gaming console 250a to the output device 260 via a cable that is connected to the audio/video output port 206. The audio from the gaming console 250a may be transmitted to the audio transceiver 214 via a wired or wireless connection established between the base station 202 and audio transceiver 214 (e.g., interaction between communication interfaces 118 and 128 of audio system 100). In some embodiments, a user may use the audio transceiver 214 to establish a chat session for online game play and/or digital content creation (e.g., creating streaming or on-demand video content for Twitch, Discord, etc.). In such embodiments, a chat audio connection may be established between the base station 202 and the active gaming console 250a and/or other audio device (e.g., phone, personal computer, etc.). For example, the gaming console 250a (or other audio device) may be connected with the base station 202 via a cable that is inserted into the audio transmission port 208a. Chat audio may be transmitted to the audio transceiver 214 via the connection (e.g., communication interfaces 118, 128) established between the base station 202 and audio transceiver 214, where the audio may be played and/or mixed with the game audio via one or more speakers of the audio transceiver 214. The audio transmission ports 208b and 208c and audio/video input port 204b may be inactive in this configuration, and no signals are transmitted via these ports.

FIG. 2C illustrates the audio system 200 with the audio transceiver 214 being docked with the base station 202 and with the second audio/video input port 204b in an active state. In this configuration, the gaming console 250b is able to transmit audio and video signals to the output device 260 via the base station 202. For example, audio/video signals from the gaming console 250b may be transmitted to the base station 202 via a cable that is connected with the second audio/video input port 204b. The base station 202 may transmit the audio/video signals from the gaming console 250b to the output device 260 via a cable that is connected to the audio/video output port 206. The audio transmission ports 208 and audio/video input port 204a are inactive, and no signals are transmitted via these ports.

FIG. 2D illustrates the audio system 200 with the audio transceiver 214 being undocked from the base station 202 and with the second audio/video input port 204b in an active state. Upon detecting that the audio transceiver 214 is undocked, the base station 202 may route audio from the gaming console 250b to the audio transceiver 214, rather than the output device 260. For example, in this configuration, the gaming console 250b is able to transmit audio and video signals to the output device 260 via the base station 202. For example, audio/video signals from the gaming console 250b may be transmitted to the base station 202 via a cable that is connected with the second audio/video input port 204b. The base station 202 may transmit the video signals from the gaming console 250b to the output device 260 via a cable that is connected to the audio/video output port 206. The audio from the gaming console 250b may be transmitted to the audio transceiver 214 via the connection established between the base station 202 and audio transceiver 214. In some embodiments, a user may use the audio transceiver 214 to establish a chat session for online game play and/or digital content creation (e.g., creating streaming or on-demand video content for Twitch, Discord, etc.). In such embodiments, a chat audio connection may be established between the base station 202 and the active gaming console 250b and/or other audio device (e.g., phone, personal computer, etc.). For example, the gaming console 250b (or other audio device) may be connected with the base station 202 via a cable that is inserted into the audio transmission port 208b. Chat audio may be transmitted to the audio transceiver 214 via the connection established between the base station 202 and audio transceiver 214, where the audio may be played and/or mixed with the game audio via one or more speakers of the audio transceiver 214. The audio transmission ports 208a and 208c and audio/video input port 204a may be inactive in this configuration, and no signals are transmitted via these ports.

FIG. 2E illustrates the audio system 200 with the audio transceiver 214 being undocked from the base station 202 and with the audio transmission port 208c in an active state. This may occur, for example, when a personal computer 250c or other input device having one or more dedicated monitors is connected with the audio system 200. For example, the audio/video signals providing game (or other media) audio may be provided directly to displays and/or speakers of the personal computer 250c such that no game audio is transmitted to the base station 202 when the audio transceiver 214 is docked. When undocked, the game video signals may continue to be transmitted directly to the monitors (e.g., do not pass through the base station 202), while the game audio may be transmitted to the audio transceiver 214. For example, audio from the personal computer 250c may be transmitted to base station 202 via a cable that is inserted into the audio transmission port 208c, with the base station 202 transmitting the game audio to the audio transceiver 214 via the connection established between the base station 202 and audio transceiver 214. In some embodiments, a user may use the audio transceiver 214 to establish a chat session for online game play and/or digital content creation (e.g., creating streaming or on-demand video content for Twitch, Discord, etc.). In such embodiments, a chat audio connection may be established between the base station 202 and the personal computer 250c. For example, the personal computer 250c may be connected with the base station 202 via the cable inserted into the audio transmission port 208c. Chat audio may be transmitted to the audio transceiver 214 via the connection established between the base station 202 and audio transceiver 214, where the audio may be played and/or mixed with the game audio via one or more speakers of the audio transceiver 214. The audio transmission ports 208a and 208b and audio/video input ports 204 may be inactive in this configuration, and no signals are transmitted via these ports.

In some embodiments, one or more of the gaming consoles 250a, 250b may be operated in enhanced audio return channel (eARC) mode, in which audio and video outputs of the gaming consoles 250a, 250b are directly connected with an output device, such as output device 260. In such embodiments, when the audio transceiver 214 is docked, the game video and audio signals are transmitted directly to the output device 260, bypassing the base station 202. Thus, switching audio/video inputs/sources may be performed via a controller of the output device 260 and/or of the gaming consoles 250a, 250b, rather than using the input switching capabilities of the base station 202. When a user wishes to play the game audio using the speakers of the audio transceiver 214, the audio transceiver 214 may be undocked from the base station 202. Upon detecting that the audio transceiver 214 is undocked, the base station 202 may route audio from the gaming console 250a, 250b to the audio transceiver 214, rather than the output device 260.

FIG. 2F illustrates the gaming console 250a operating in an eARC mode with the audio system 200 while the audio transceiver 214 is undocked from the base station 202. In this configuration, the game audio and video signals from the gaming console 250a are transmitted directly to the output device 260. The output device 260 may be connected with the base station 202 via a cable that is inserted into the audio/video output port 206 and may transmit game audio to the base station 202 via this connection. The audio from the gaming console 250a may be transmitted to the audio transceiver 214 via the connection established between the base station 202 and audio transceiver 214. In some embodiments, a user may use the audio transceiver 214 to establish a chat session for online game play and/or digital content creation (e.g., creating streaming or on-demand video content for Twitch, Discord, etc.). In such embodiments, a chat audio connection may be established between the base station 202 and the active gaming console 250a and/or other audio device (e.g., phone, personal computer, etc.). For example, the gaming console 250a (or other audio device) may be connected with the base station 202 via a cable that is inserted into the audio transmission port 208a. Chat audio may be transmitted to the audio transceiver 214 via the connection established between the base station 202 and audio transceiver 214, where the audio may be played and/or mixed with the game audio via one or more speakers of the audio transceiver 214. The audio transmission ports 208b and 208c and audio/video input ports 204 may be inactive in this configuration, and no signals are transmitted via these ports.

FIG. 2G illustrates the gaming console 250b operating in an eARC mode with the audio system 200 while the audio transceiver 214 is undocked from the base station 202. In this configuration, the game audio and video signals from the gaming console 250b are transmitted directly to the output device 260. The output device 260 may be connected with the base station 202 via a cable that is inserted into the audio/video output port 206 and may transmit game audio to the base station 202 via this connection. The audio from the gaming console 250b may be transmitted to the audio transceiver 214 via the connection established between the base station 202 and audio transceiver 214. In some embodiments, a user may use the audio transceiver 214 to establish a chat session for online game play and/or digital content creation (e.g., creating streaming or on-demand video content for Twitch, Discord, etc.). In such embodiments, a chat audio connection may be established between the base station 202 and the active gaming console 250b and/or other audio device (e.g., phone, personal computer, etc.). For example, the gaming console 250b (or other audio device) may be connected with the base station 202 via a cable that is inserted into the audio transmission port 208b. Chat audio may be transmitted to the audio transceiver 214 via the connection established between the base station 202 and audio transceiver 214, where the audio may be played and/or mixed with the game audio via one or more speakers of the audio transceiver 214. The audio transmission ports 208a and 208c and audio/video input ports 204 may be inactive in this configuration, and no signals are transmitted via these ports.

It will be appreciated that the configurations of the audio system 200 described above are merely provided as examples and that numerous variations may exist. For example, the base station 202 may include more or fewer input/output ports, and different devices (e.g., other than gaming consoles and personal computers) may be connected to the base station 202. In some embodiments, an LED and/or other visible indicator associated with a given input device 250 may be illuminated and/or otherwise activated to inform a user as to which input device 250 is currently active. Switching between the various input devices 250 may be performed using input controls on the base station 202 and/or audio transceiver 214 as discussed in greater detail below.

FIG. 3 illustrates a method 300 of operating a base station in accordance with embodiments of the present invention. The method 300 may describe operations of base stations 102 and 202, such as functions controlled by the control module 120. The method 300 may illustrate how switching between various input devices (such as illustrated in FIGS. 2A-2G) may be performed by a base station. The method 300 may also illustrate how the base station switches from supplying audio to an output device (e.g., a television, monitor, and/or connected speaker) to an audio transceiver (such as audio transceivers 114 and 214) when the audio transceiver is undocked from the base station. The method 300 may begin at operation 302 by detecting that an audio transceiver has been undocked from the base station. This may be done, for example, by detecting that an electrical connector (such as a pin) of the audio transceiver has been disengaged from an electrical connector of the base station. Other forms of detecting that the audio transceiver has been undocked may be used in various embodiments. For example, load sensors, proximity sensors, optical sensors, and the like may be used to detect when the audio transceiver is in a docked or undocked state. Additionally, in some embodiments, the audio transceiver may be determined to be docked when the audio transceiver is unpowered (e.g., a battery of the audio transceiver has no charge), which may be detected by the base station receiving no response from the audio transceiver via the communication interfaces.

In response to detecting that the audio transceiver has been undocked from the audio/video base station, at operation 304 the base station may automatically switch an audio output signal from an audio/video output port of the base station to a communication interface (e.g., wired or wireless connection between the communication interface 118 of the base station and the communication interface 128 of the audio transceiver) while continuing to transmit a video output signal to an audio/video output port of the base station. For example, the base station may halt transmission of a first audio signal (e.g., a game audio signal) associated with a first input device (e.g., input device 250) to a first selected output device (e.g., a television or other output device 260). The base station may then transmit the first audio signal to the audio transceiver while continuing to transmit a first video signal (e.g., a game video signal) associated with the first input device to the first selected output device. Prior to undocking the audio transceiver from the base station, both the first audio signal and the first video signal may have been transmitted to the output device and/or a connected speaker, enabling the input device (e.g., gaming console) to be used independently of the audio transceiver.

At operation 306, the method 300 may include the base station receiving an input from the audio transceiver to switch to a second input device (e.g., a second gaming console). For example, a user may press a button and/or otherwise interact with an input select interface (e.g., input select interface 136) of the audio transceiver to change sources/inputs for audio and video to the base station. The audio transceiver may send a command to the base station to initiate a switch of input devices. With each button press or other switching input, the base station may incrementally cycle through the available input devices. If no input device is connected to a given audio/video input device, the associated input device channel may be skipped. Once the user has stopped cycling through input devices, the base station may determine whether the selected input device is the same or different than the current input device. If the selected input device is the same as the current input device, the base station may take no action (e.g., will not initiate a switch operation). If the selected input device is different than the current input device, the base station may initiate a switching operation as described below.

At operation 308, the base station may automatically switch the source/input from the first input device to the second input device. The input switching may involve the base station, for example, halting transmission of the first video signal from an audio/video output port to the first selected output device. The base station may also halt transmission of the first audio signal to the audio transceiver. The base station may transmit a second audio signal (e.g., a game audio signal) associated with the second input device to the audio transceiver, such as via the communication interfaces of the base station and the audio transceiver. The base station may transmit a second video signal associated with the second input device to a second selected output device. In some embodiments, the first selected output device and the second selected output device may be the same device, such as a television or other output device 260. In such embodiments, the second video signal may be transmitted to the output device via the same audio/video output port of the base station that was used to transmit the first video signal.

In some embodiments, the base station may be programmed to meet predefined timing criteria for switching to a new video source. Such timing criteria may be important to provide a video blanking experience for the end user and to avoid a false sense of abnormal operation associated with the base station and connected video source. These timings may be very difficult to manage among various television brands and models. To address such issues, the base station may recognize specific brands/models HDMI high-bandwidth digital content protection (HDCP), HDMI link training behavior, and/or other metrics from the television. Based on the recognized metrics from the television brand and model, the base station may then optimize the timings for the video to show up on the television. To provide an acceptable range for the end user, timings associated with the video switching process may include, without limitation: HDMI Source switching video activation period in less than or equal to 5 seconds, activation of video after physical plugging/unplugging of the HDMI cable video of less than or equal to 10 seconds, an HDR, HDCP, Deep Color togging video activation period of less than or equal to 10 seconds, and/or audio latency from HDMI source to sink of less than or equal to 2 ms. It will be appreciated that other timing criteria may be present in some embodiments, and that one or more of the time periods within the timing criteria may be different than those listed above in various embodiments.

In some embodiments, the base station may include one or more visual indicators, such as LEDs, that may be used to provide an indication of which input/source device is currently active for transmission of audio and/or video signals to the base station. In such embodiments, upon receiving the input from the audio transceiver to switch to a second input device, the base station may deactivate a visible indicator associated with the first input device and activate a visible indicator associated with the second input device. In some embodiments, the visible indicators may be switched (e.g., deactivated/activated) quicker than the audio and/or video signals, which may cause issues where the active visual indicator does not immediately match the active audio and/or video inputs due to lag in the audio/video switching process. In such embodiments, the switching of the audio and/or video inputs may be delayed until after a predefined time delay (such as about 0.25 seconds or less, 0.5 seconds or less, 1 second or less, etc.) has elapsed from when the user has stopped cycling inputs, while the switching of the visible indicators happens immediately upon receiving the input from the audio transceiver to switch to a second input device. Such a configuration may enable the visible indicators to provide a real-time indication of which input device is active as a user cycles through the available input devices. Once the user settles on a desired input device for a sufficient amount of time to suggest that the user wants to utilize the selected input device (e.g., after the predefined time delay has elapsed, any audio and/or video switching may be commenced. In some embodiments, when cycling through the input devices, if no input device is connected to a given audio/video input port, the base station may skip the empty audio/video input port without activating the associated visible indicator.

In some embodiments, the base station may establish a chat audio session that enables the user to join an online multiplayer chat and/or to provide chat commentary over a video and/or gaming feed, such as to produce social media content. For example, the base station may establish a first audio channel between the output device (e.g., via the audio/video output port) and a respective audio transmission port associated with an active input device (e.g., via an audio/video input port). When the base station determines that the audio transceiver is undocked from the base station, the base station may terminate the first audio channel (e.g., stop sending chat audio associated with the first output device) and establish a second audio channel between the communication interface and the respective audio transmission port associated with the active second input device to enable chat audio associated with the second input device to be transmitted to the audio transceiver. When the base station receives the input from the audio transceiver to switch to a second input device, the base station may terminate the second audio channel and may establish a third audio channel between the communication interface and the second input device (e.g., between the audio transmission port associated with the audio/video input port associated with the second input device).

In other embodiments, the second input device may be a personal computer or other device that is directly connected to and/or otherwise includes output devices, such as a monitor and/or speaker. In such embodiments, the base station may not be involved in transmission of any audio signals from the first input device or video signals from either input device. In such embodiments, the base station may receive an audio signal (e.g., a game audio signal) associated with the second input device (e.g., from the personal computer to an audio transmission port of the base station). The base station may transmit the audio signal to the audio transceiver, such as via the communication interfaces of the base station and the audio transceiver.

In some embodiments, the base station may receive a mixing command associated with a volume level of an audio signal (e.g., game audio) and an audio channel (e.g., chat audio). Based on the mixing command, the base station may adjust a relative volume of the audio signal and/or the audio channel. In some embodiments, the adjustment of volume may be done by raising the volume of one of the audio signal and the audio channel and lowering the volume of the other of the audio signal and the audio channel, possibly without adjusting a master volume of the audio transceiver. This may enable the master volume to stay constant while adjusting a ratio of the game and chat audio to enable a user to select whether to hear more game, more chat, or a balance of both game and chat audio. In some embodiments, the mixing command may be received from the audio transceiver. For example, a user may interact with one or more buttons or other inputs of a volume mixing interface 134 of the audio transceiver to send the mixing command to the base station for adjusting the mixing of the game audio and chat audio. In other embodiments, the mixing command may originate from audio mixing software executed on an external device that is communicatively coupled with the base station, such as via a Bluetooth connection. For example, the external device may include equalizer and/or other mixing software that may enable the user to adjust the mixing and/or master volume of the audio transmitted to the audio transceiver.

Audio mixing may be handled in different manners when the base station switches to a new input device. For example, in some instances, the base station may reset the game audio and chat audio balance to 50:50 (or another ratio), while in other instances, the base station may carry over the game audio and chat audio balance that was being used prior to the switch. In other embodiments, the user may be able to set default mixing levels and/or master volume levels for one or more of the input devices. In some embodiment, the master volume of the audio transmitted to the audio transceiver may be reset to a predetermined level and/or maintained at a current level. In some embodiments, the master volume may be capped at a certain threshold volume (e.g., 70%, 60%, 50%, 40%, 30% relative to a maximum volume, etc.) upon switching. For example, if the current volume is less than or equal to the threshold volume, the current volume may be carried over to the next input device, but if the current volume exceeds the threshold volume, the master volume may be reset to the threshold volume (or another volume level). To facilitate the comparison, the base station may delay transmission of the audio signal to the audio transmission for a short period of time (e.g., less than 1 second, less than 0.5 seconds, less than 0.25 seconds, or less) to listen to or otherwise monitor the new audio signal to determine the current volume level prior to comparing the current volume to the threshold and/or making any necessary adjustments to the master volume.

In some embodiments, the base station may detect that the audio transceiver has been docked with the base station. For example, this may be done by detecting that an electrical connector (such as a pin) of the audio transceiver has been engaged with an electrical connector of the base station. Other forms of detecting that the audio transceiver has been docked may be used in various embodiments. For example, load sensors, proximity sensors, optical sensors, and the like may be used to detect when the audio transceiver is in a docked or undocked state. Additionally, in some embodiments, the audio transceiver may be determined to be docked when the audio transceiver is unpowered (e.g., a battery of the audio transceiver has no charge). In response to detecting that the audio transceiver has been docked with the base station, the base station may automatically switch the game and/or chat audio back to the output device. For example, the base station may halt transmission of an audio signal to the audio transceiver and instead transmit an audio signal to the output device while continuing to transmit a current video signal to the selected output device. When the selected output device is a personal computer, there may be no change in video signals, and the game and/or chat audio may be transferred back to the personal computer and/or associated speakers.

In some embodiments, HDMI consumer electronics control (CEC) functionality (or similar functionality for other transmission protocols) may be used to detect changes in operation of a connected audio/video source. For example, if an HDMI source operating state is changed, the base station may optimize the audio selection and switching to allow for the base station front panel (e.g., visual indicators) and headset user interface (e.g., control module) to control the source switching more efficiently. As just one example, if source A is active and source B decides to go to sleep or power down mode, then the base station may change user interface behavior to avoid switching to a non-active source. For example, if the user interacts with the input select interface of the audio transceiver to switch input sources and a next inactive audio/video source is asleep or powered down (e.g., in an off state), the base station may automatically skip the asleep or powered down audio/video source and switch to the next connected audio/video source that is in an active state. This may ensure that the end user does not switch to powered down sources and may enable the switching to be more efficient, as only active sources are available for switching operations. Additionally, HDMI CEC may allow for On Screen Display (OSD). In some embodiments, the base station will be able to output audio source information and volume equalizer settings for display on the television (or other connected output device) screen. This may enable the end user to better visualize and/or adjust the current audio settings for audio being transmitted from the base station to the audio transceiver.

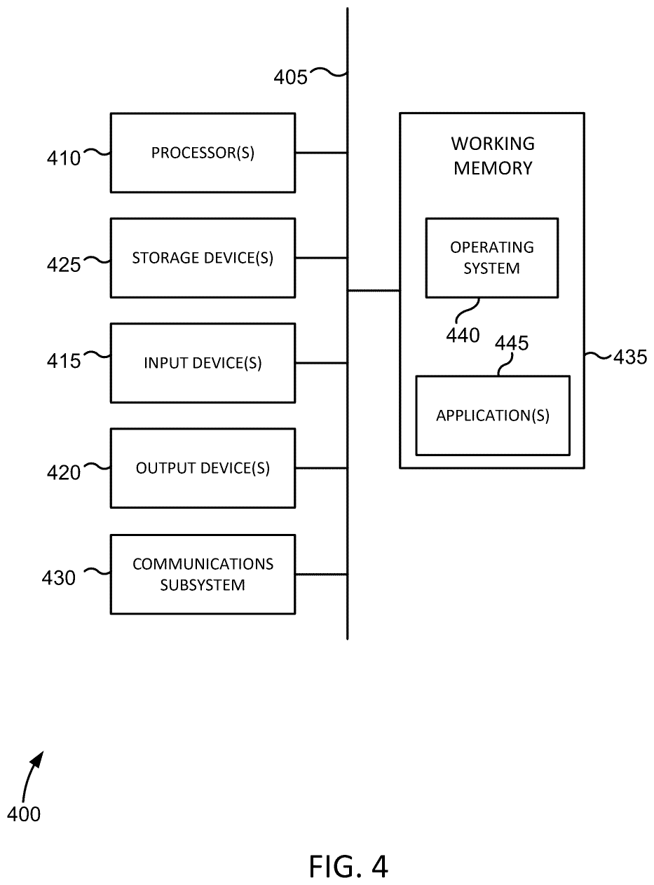

A computer system as illustrated in FIG. 4 may be incorporated as part of the previously described computerized devices. For example, computer system 400 can represent some of the components of computing devices, such as the base stations 102, 202 (including control module 120), audio transceivers 114, 214 (including control module 140), input devices 250, output devices 260, and/or other computing devices described herein. FIG. 4 provides a schematic illustration of one embodiment of a computer system 400 that can perform the methods provided by various other embodiments, as described herein. FIG. 4 is meant only to provide a generalized illustration of various components, any or all of which may be utilized as appropriate. FIG. 4, therefore, broadly illustrates how individual system elements may be implemented in a relatively separated or relatively more integrated manner. The computer system 400 is shown comprising hardware elements that can be electrically coupled via a bus 405 (or may otherwise be in communication, as appropriate). The hardware elements may include a processing unit 410, including without limitation one or more processors, such as one or more central processing units (CPUs), graphical processing units (GPUs), special-purpose processors (such as digital signal processing chips, graphics acceleration processors, and/or the like); one or more input devices 415, which can include without limitation a keyboard, a touchscreen, receiver, a motion sensor, a camera, a smartcard reader, a contactless media reader, and/or the like; and one or more output devices 420, which can include without limitation a display device, a speaker, a printer, a writing module, and/or the like.

The computer system 400 may further include (and/or be in communication with) one or more non-transitory storage devices 425, which can comprise, without limitation, local and/or network accessible storage, and/or can include, without limitation, a disk drive, a drive array, an optical storage device, a solid-state storage device such as a random access memory (“RAM”) and/or a read-only memory (“ROM”), which can be programmable, flash-updateable and/or the like. Such storage devices may be configured to implement any appropriate data stores, including without limitation, various file systems, database structures, and/or the like.

The computer system 400 might also include a communication interface 430, which can include without limitation a modem, a network card (wireless or wired), an infrared communication device, a wireless communication device and/or chipset (such as a Bluetooth™ device, a 502.11 device, a Wi-Fi device, a WiMAX device, an NFC device, cellular communication facilities, etc.), and/or similar communication interfaces. The communication interface 430 may permit data to be exchanged with a network (such as the network described below, to name one example), other computer systems, and/or any other devices described herein. In many embodiments, the computer system 400 will further comprise a non-transitory working memory 435, which can include a RAM or ROM device, as described above.

The computer system 400 also can comprise software elements, shown as being currently located within the working memory 435, including an operating system 440, device drivers, executable libraries, and/or other code, such as one or more application programs 445, which may comprise computer programs provided by various embodiments, and/or may be designed to implement methods, and/or configure systems, provided by other embodiments, as described herein. Merely by way of example, one or more procedures described with respect to the method(s) discussed above might be implemented as code and/or instructions executable by a computer (and/or a processor within a computer); in an aspect, then, such special/specific purpose code and/or instructions can be used to configure and/or adapt a computing device to a special purpose computer that is configured to perform one or more operations in accordance with the described methods.

A set of these instructions and/or code might be stored on a computer-readable storage medium, such as the storage device(s) 425 described above. In some cases, the storage medium might be incorporated within a computer system, such as computer system 400. In other embodiments, the storage medium might be separate from a computer system (e.g., a removable medium, such as a compact disc), and/or provided in an installation package, such that the storage medium can be used to program, configure and/or adapt a special purpose computer with the instructions/code stored thereon. These instructions might take the form of executable code, which is executable by the computer system 400 and/or might take the form of source and/or installable code, which, upon compilation and/or installation on the computer system 400 (e.g., using any of a variety of available compilers, installation programs, compression/decompression utilities, etc.) then takes the form of executable code.

Substantial variations may be made in accordance with specific requirements. For example, customized hardware might also be used, and/or particular elements might be implemented in hardware, software (including portable software, such as applets, etc.), or both. Moreover, hardware and/or software components that provide certain functionality can comprise a dedicated system (having specialized components) or may be part of a more generic system. For example, a risk management engine configured to provide some or all of the features described herein relating to the risk profiling and/or distribution can comprise hardware and/or software that is specialized (e.g., an application-specific integrated circuit (ASIC), a software method, etc.) or generic (e.g., processing unit 410, applications 445, etc.) Further, connection to other computing devices such as network input/output devices may be employed.

Some embodiments may employ a computer system (such as the computer system 400) to perform methods in accordance with the disclosure. For example, some or all of the procedures of the described methods may be performed by the computer system 400 in response to processing unit 410 executing one or more sequences of one or more instructions (which might be incorporated into the operating system 440 and/or other code, such as an application program 445) contained in the working memory 435. Such instructions may be read into the working memory 435 from another computer-readable medium, such as one or more of the storage device(s) 425. Merely by way of example, execution of the sequences of instructions contained in the working memory 435 might cause the processing unit 410 to perform one or more procedures of the methods described herein.

The terms “machine-readable medium” and “computer-readable medium,” as used herein, refer to any medium that participates in providing data that causes a machine to operate in a specific fashion. In an embodiment implemented using the computer system 400, various computer-readable media might be involved in providing instructions/code to processing unit 410 for execution and/or might be used to store and/or carry such instructions/code (e.g., as signals). In many implementations, a computer-readable medium is a physical and/or tangible storage medium. Such a medium may take many forms, including but not limited to, non-volatile media, volatile media, and transmission media. Non-volatile media include, for example, optical and/or magnetic disks, such as the storage device(s) 425. Volatile media include, without limitation, dynamic memory, such as the working memory 435. Transmission media include, without limitation, coaxial cables, copper wire, and fiber optics, including the wires that comprise the bus 405, as well as the various components of the communication interface 430 (and/or the media by which the communication interface 430 provides communication with other devices). Hence, transmission media can also take the form of waves (including without limitation radio, acoustic and/or light waves, such as those generated during radio-wave and infrared data communications).

Common forms of physical and/or tangible computer-readable media include, for example, a magnetic medium, optical medium, or any other physical medium with patterns of holes, a RAM, a PROM, EPROM, a FLASH-EPROM, any other memory chip or cartridge, a carrier wave as described hereinafter, or any other medium from which a computer can read instructions and/or code.

The communication interface 430 (and/or components thereof) generally will receive the signals, and the bus 405 then might carry the signals (and/or the data, instructions, etc. carried by the signals) to the working memory 435, from which the processor(s) 410 retrieves and executes the instructions. The instructions received by the working memory 435 may optionally be stored on a non-transitory storage device 425 either before or after execution by the processing unit 410.

In the embodiments described above, for the purposes of illustration, processes may have been described in a particular order. It should be appreciated that in alternate embodiments, the methods may be performed in a different order than that described. It should also be appreciated that the methods and/or system components described above may be performed by hardware and/or software components (including integrated circuits, processing units, and the like), or may be embodied in sequences of machine-readable, or computer-readable, instructions, which may be used to cause a machine, such as a general-purpose or special-purpose processor or logic circuits programmed with the instructions to perform the methods. These machine-readable instructions may be stored on one or more machine-readable mediums, such as CD-ROMs or other type of optical disks, floppy disks, ROMs, RAMs, EPROMS, EEPROMs, magnetic or optical cards, flash memory, or other types of machine-readable mediums suitable for storing electronic instructions. Alternatively, the methods may be performed by a combination of hardware and software.

The methods, systems, devices, graphs, and tables discussed herein are examples. Various configurations may omit, substitute, or add various procedures or components as appropriate. For instance, in alternative configurations, the methods may be performed in an order different from that described, and/or various stages may be added, omitted, and/or combined. Also, features described with respect to certain configurations may be combined in various other configurations. Different aspects and elements of the configurations may be combined in a similar manner. Also, technology evolves and, thus, many of the elements are examples and do not limit the scope of the disclosure or claims. Additionally, the techniques discussed herein may provide differing results with different types of context awareness classifiers.

While illustrative and presently preferred embodiments of the disclosed systems, methods, and machine-readable media have been described in detail herein, it is to be understood that the inventive concepts may be otherwise variously embodied and employed, and that the appended claims are intended to be construed to include such variations, except as limited by the prior art.

Unless defined otherwise, all technical and scientific terms used herein have the same meaning as commonly or conventionally understood. As used herein, the articles “a” and “an” refer to one or to more than one (i.e., to at least one) of the grammatical object of the article. By way of example, “an element” means one element or more than one element. “About” and/or “approximately” as used herein when referring to a measurable value such as an amount, a temporal duration, and the like, encompasses variations of +20% or +10%, +5%, or +0.1% from the specified value, as such variations are appropriate to in the context of the systems, devices, circuits, methods, and other implementations described herein. “Substantially” as used herein when referring to a measurable value such as an amount, a temporal duration, a physical attribute (such as frequency), and the like, also encompasses variations of +20% or +10%, +5%, or +0.1% from the specified value, as such variations are appropriate to in the context of the systems, devices, circuits, methods, and other implementations described herein.

As used herein, including in the claims, “and” as used in a list of items prefaced by “at least one of” or “one or more of” indicates that any combination of the listed items may be used. For example, a list of “at least one of A, B, and C” includes any of the combinations A or B or C or AB or AC or BC and/or ABC (i.e., A and B and C). Furthermore, to the extent more than one occurrence or use of the items A, B, or C is possible, multiple uses of A, B, and/or C may form part of the contemplated combinations. For example, a list of “at least one of A, B, and C” may also include AA, AAB, AAA, BB, etc.

What is claimed is:

1. An audio/video base station, comprising:
a plurality of audio/video input ports;
an audio/video output port;
a communication interface that is coupleable with an audio transceiver;
one or more processors; and
a memory device having instructions stored thereon that, when executed by the one or more processors, cause the audio/video base station to:
detect that the audio transceiver has been undocked from the audio/video base station; and
in response to detecting that the audio transceiver has been undocked from the audio/video base station, automatically switching an audio output signal from the audio/video output port to the communication interface while continuing to transmit a video output signal to the audio/video output port.

2. The audio/video base station of claim 1, further comprising:
a plurality of audio transmission ports, each of the plurality of audio transmission ports being associated with a respective one of the plurality of audio/video input ports, wherein the instructions further cause the audio/video base station to:
terminate a first audio channel between the audio/video output port and a respective audio transmission port associated with an active one of the plurality of audio/video input ports; and
establish a second audio channel between the communication interface and the respective audio transmission port associated with the active one of the plurality of audio/video input ports.

3. The audio/video base station of claim 2, wherein:
the instructions further cause the audio/video base station to:
receive an input from the audio transceiver to switch to a different one of the plurality of audio/video input ports; and
in response to receiving the input, automatically:
terminate the second audio channel; and
establish a third audio channel between the communication interface and the respective audio transmission port associated with the different one of the plurality of audio/video input ports.

4. The audio/video base station of claim 2, wherein:
at least some of the plurality of audio transmission ports comprise descriptors associated with a specific audio/video input device.

5. The audio/video base station of claim 1, wherein:
the instructions further cause the audio/video base station to:
receive an input from the audio transceiver to switch to a different one of the plurality of audio/video input ports; and
in response to receiving the input, automatically:
halt transmission of the video output signal to the audio/video output port;
halt transmission of the audio output signal;
transmit a new audio output signal associated with the different one of the plurality of audio/video input ports to the communication interface; and
transmit a new video signal associated with the different one of the plurality of audio/video input ports to the audio/video output port.

6. The audio/video base station of claim 1, further comprising:
a plurality of visible indicators, each of the plurality of visible indicators being associated with a respective one of the plurality of audio/video input ports, wherein the instructions further cause the audio/video base station to activate a respective one of the visible indicators associated with a selected one of the plurality of audio/video input ports that is associated with the video output signal that is being transmitted to the audio/video output port.

7. The audio/video base station of claim 6, wherein:
the instructions further cause the audio/video base station to:
receive an input from the audio transceiver to switch to a different one of the plurality of audio/video input ports;
deactivate the respective one of the visible indicators associated with the selected one of the plurality of audio/video input ports;
activate a respective one of the visible indicators associated with the different one of the plurality of audio/video input ports; and
after a predefined time delay has elapsed:
halt transmission of the video output signal to the audio/video output port;
halt transmission of the audio output signal;
transmit a new audio output signal associated with the different one of the plurality of audio/video input ports to the communication interface; and
transmit a new video signal associated with the different one of the plurality of audio/video input ports to the audio/video output port.

8. A method of switching audio channels of a base station, comprising:
detecting, by a base station, that an audio transceiver has been undocked from the base station;
in response to detecting that the audio transceiver has been undocked from the base station, automatically:
halting transmission, by the base station, of a first audio signal associated with a first input device to a first selected output device; and
transmitting, by the base station, the first audio signal to the audio transceiver while continuing to transmit a first video signal associated with the first input device to the first selected output device;
receiving, by the base station, an input from the audio transceiver to switch to a second input device; and
in response to receiving the input, automatically:
halting transmission, by the base station, of the first video signal to the first selected output device;
halting transmission, by the base station, of the first audio signal to the audio transceiver;
transmitting, by the base station, a second audio signal associated with the second input device to the audio transceiver; and
transmitting, by the base station, a second video signal associated with the second input device to a second selected output device.

9. The method of switching audio channels of a base station of claim 8, further comprising:
establishing, by the base station an audio channel between the audio transceiver and an audio transmission port of the base station that is associated with the second input device;
receiving, by the base station, a mixing command associated with a volume level of one or both of the second audio signal and the audio channel; and
adjusting, by the base station, a volume of the one or both of the second audio signal and the audio channel in response to receiving the mixing command.

10. The method of switching audio channels of a base station of claim 9, wherein:
the mixing command comprises an input received from the audio transceiver.

11. The method of switching audio channels of a base station of claim 9, wherein:
the mixing command comprises an input received from audio mixing software executed on an external device that is communicatively coupled with the base station.

12. The method of switching audio channels of a base station of claim 9, wherein:
adjusting the volume of the one or both of the second audio signal and the audio channel comprises raising the volume of one of the second audio signal and the audio channel and lowering the volume of the other of the second audio signal and the audio channel without adjusting a master volume of the audio transceiver.

13. The method of switching audio channels of a base station of claim 8, further comprising:
detecting, by the base station, that the audio transceiver has been docked with the base station;
in response to detecting that the audio transceiver has been docked with the base station, automatically:
halting transmission, by the base station, of the second audio signal associated with the second input device to the audio transceiver; and
transmitting, by the base station, a third audio signal associated with the second input device to the second selected output device while continuing to transmit the second video signal to the second selected output device.

14. The method of switching audio channels of a base station of claim 8, wherein:
the first output device and the second output device are the same device.

15. An audio/video system, comprising:
an audio transceiver, comprising:
input select interface; and
a volume mixing interface; and
a base station, comprising:
a plurality of audio/video input ports;
an audio/video output port;
a communication interface that is coupled with the audio transceiver;
one or more processors; and
a memory device having instructions stored thereon that, when executed by the one or more processors, cause the base station to:
detect that the audio transceiver has been undocked from the base station; and
in response to detecting that the audio transceiver has been undocked from the base station, automatically switching an audio signal from the audio/video output port to the communication interface while continuing to transmit a video signal to the audio/video output port.

16. The audio/video system of claim 15, wherein:
the instructions further cause the base station to:
receive an input from the input select interface to switch to a different one of the plurality of audio/video input ports; and
in response to receiving the input, automatically:
halt transmission of the video output signal to the audio/video output port;
halt transmission of the audio output signal;
transmit a new audio output signal associated with the different one of the plurality of audio/video input ports to the communication interface; and
transmit a new video signal associated with the different one of the plurality of audio/video input ports to the audio/video output port.

17. The audio/video system of claim 15, wherein:
detecting that the audio transceiver has been undocked from the base station comprises the base station detecting that an electrical connector of the audio transceiver has been disengaged from an electrical connector of the base station.

18. The audio/video system of claim 15, wherein:
the communication interface comprises a radio connection established between the audio transceiver and the base station.

19. The audio/video system of claim 15, wherein:
the base station further comprises a Bluetooth antenna;
the audio transceiver comprises one or more controls for the Bluetooth antenna; and
the instructions further cause the base station to:
receive an audio transmission from a connected device via the Bluetooth antenna; and
transmit the audio transmission to the audio transceiver over the communication interface.

20. The audio/video system of claim 15, wherein:
the audio transceiver comprises a headset.
